(19) United States
(12) Patent Application Publication
(10) Pub. No.: US 2010/0257289 A1
(43) Pub. Date: Oct. 7, 2010

(54) DMA CONTROLLER, INFORMATION PROCESSING DEVICE AND DMA MANAGEMENT METHOD

(75) Inventor: Yousuke SASAKI, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/732,897

(22) Filed: Mar. 26, 2010

(30) Foreign Application Priority Data
Apr. 2, 2009 (JP) 2009-089875

(51) Int. Cl. G06F 13/28

(52) U.S. Cl. 710/22; 710/308

(57) ABSTRACT

A DMA controller includes an information manager and a signal generator. The information manager manages individual information by grouping the information according to grouping of a DMA transfer corresponding to relativity between the DMA transfer individually executed. The individual information corresponds to individual DMA transfer. The signal generator generates a signal based on the individual information managed by the information manager. The signal indicates a completion of the DMA transfer in group of the DMA transfer. It is possible to prevent redundant information from being transmitted through the bus by informing a CPU of completion of the DMA transfer in a unit of group.

### INCORPORATION BY REFERENCE

This application is based upon and claims the benefit of priority from Japanese patent application No. 2009-089875, filed on Apr. 2, 2009, the disclosure of which is incorporated herein in its entirety by reference.

### BACKGROUND

1. Field of the Invention

The present invention relates to DMA (Direct Memory Access) controller, information processing device and DMA management method.

2. Description of Related Art

Recently, increase of data transfer rate is significant in accordance with increase of capacity of storage devices. Further, data amount which storage devices handle increases up to tens of gigabytes.

In serial ATA in which data transfer in performed with a serial method, standardization of 6 Gbps is examined against a backdrop of prevalence of transfer standard of 3 Gbps. In addition to physical speed-up, other speed-up such as native command queuing are addressed. In the native command queuing, a number of transfer orders are received at a time, and then transfer processing is performed by changing sequence of these transfer orders. According to such a technique, data transfer rate of the storage device itself has been increased.

High-capacity data uses a system bus in a semiconductor integrated circuit as well as a bus which connects between semiconductor integrated circuits. Therefore, increase of data transfer rate on a system bus of a semiconductor integrated circuit is required.

Japanese Unexamined Patent Application Publication No. 2004-287654 (Suzuki) discloses a DMA transfer device which executes multiple DMA transfers in a single boot DMA transfer and to report the end of the multiple DMA transfers to a CPU independently from polling of the CPU.

### SUMMARY

However, in above Suzuki case, occurrence of interruptions is managed by number of times of termination of DMA transfer. A system in which transfer commands from plural applications are occurred in parallel can manage the occurrence of interruptions by in a unit of application. However, if a technique of Suzuki is applied to this system, it is impossible to manage the occurrence of the interruptions in a unit of application. Further, as unnecessary interruptions are generated, this leads to high bus traffic, and then data transfer efficiency of the system bus is decreased. Further, controlling of interruptions becomes redundant in accordance with generating unnecessary interruptions.

It is clear by the above description that there has been a problem that transfer efficient of the bus is decreased by transmitting redundancy information in the bus.

According to an embodiment of the present invention, there is provided a DMA controller including an information manager and a signal generator. The information manager manages individual information by grouping the information according to grouping of a DMA transfer corresponding to relativity between the DMA transfers individually executed. The individual information corresponds to individual DMA transfer. The signal generator generates a signal based on the individual information managed by the information manager. The signal indicates a completion of the DMA transfer in a unit group of the DMA transfer.

It is possible to prevent redundant information from being transmitted through the bus by informing a CPU of completion of the DMA transfer in a unit of group.

According to another embodiment of the present invention, there is provided an information processing device including a CPU (Central Processing Unit), a memory, and a DMA controller connected to the CPU and the memory through a bus. The DMA controller includes an information manager and a signal generator. The information manager manages individual information by grouping the information according to grouping of a DMA transfer corresponding to relativity between the DMA transfers individually executed. The individual information corresponds to individual DMA transfer. The signal generator generates a signal based on the individual information managed by the information manager. The signal notifies the CPU of a completion of the DMA transfer in a unit of group of the DMA transfer.

According to yet another embodiment of the present invention, there is provided A DMA managing method including the following steps (1) and (2).

(1) Storing individual information corresponding to individual DMA transfer in common memory area according to grouping of the DMA transfer corresponding to reference between the DMA transfers individually executed.

(2) Generating a signal based on the individual information stored in the memory area, the signal indicating a completion of the DMA transfer in a unit of group of the DMA transfer.

According to the present invention, bus transfer efficiency is further improved than the conventional technique.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an information processing device of an exemplary embodiment of the present invention;

FIG. 2 is a block diagram showing an interrupt controller of the exemplary embodiment of the present invention;

FIG. 3 is a block diagram showing a transfer information manager of the exemplary embodiment of the present invention;

FIG. 4 is an explanation drawing explaining grouping of transfer commands of the exemplary embodiment of the present invention;

FIG. 5 is a flow chart to explain an operation of a DMA controller of the exemplary embodiment of the present invention;

FIG. 6 is a flow chart to explain an operation of a DMA controller of the exemplary embodiment of the present invention; and

FIG. 7 is an explanation drawing showing an effect achieved by the information processing device of the exemplary embodiment of the present invention.

### DETAILED DESCRIPTION OF THE EXEMPLARY EMBODIMENTS

Hereinafter, a specific embodiment to which the present invention is applied will be described in detail with reference to the drawings. Note that, the exemplary embodiment is simplified for the sake of convenience. The technical scope of the present invention should not be limited by interpreted based on the description of figures, because all figures are simplified. Figures are entirely used for explanation of technical matters and each element shown in figures does not reflect accurate size of each element. The same components are denoted by the same reference symbols throughout the drawings, and a redundant description thereof is omitted as appropriate for clarification of the explanation. Any technique may be employed to realize function blocks, which means they may be realized by hardware or software.

### First Exemplary Embodiment

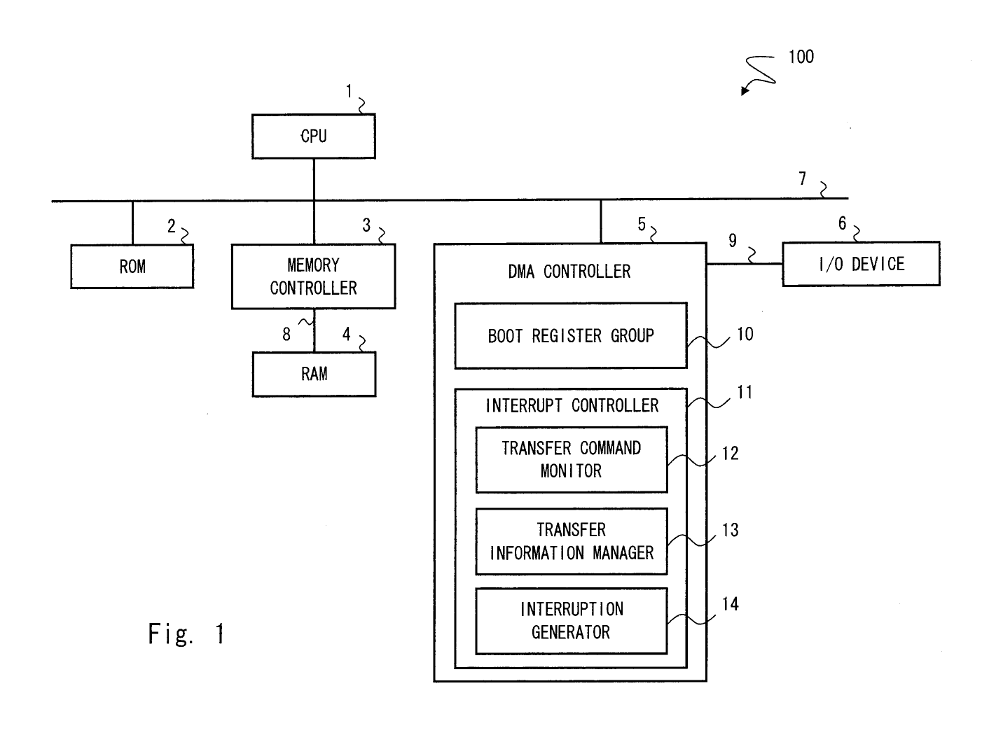

As shown in FIG. 1, an information processing device 100 includes a CPU (Central Processing Unit) 1, ROM (Read Only Memory) 2, memory controller 3, RAM (Random Access Memory) 4, DMA (Direct Memory Access) controller 5, I/O (Input/Output) device 6, bus 7, bus 8 and bus 9. The DMA controller 5 includes the boot register group 10 and an interrupt controller 11. The interrupt controller 11 includes a transfer command monitor 12, a transfer information manager 13 and an interruption generator 14. Note that, the DMA controller 5 is monolithic integrated circuit (MIC).

The CPU 1, the ROM 2, the memory controller 3 and the DMA controller 5 are connected each other through the bus 7. The memory controller 3 is connected to the RAM 4 through the bus 8. The DMA controller 5 is connected to the I/O device 6 through the bus 9.

The information processing device 100 is common computer and executes a program stored in the ROM 2 with interpreting the program by the CPU 1. The ROM 2 stores plural programs and the CPU 1 executes plural programs. While each program is executed by the CPU 1, a transfer command which orders DMA transfer is sent from the CPU 1 to the DMA controller 5. The DMA controller 5 executes DMA transfer between the RAM 4 and the I/O device 6 in response to the transfer command from the CPU 1.

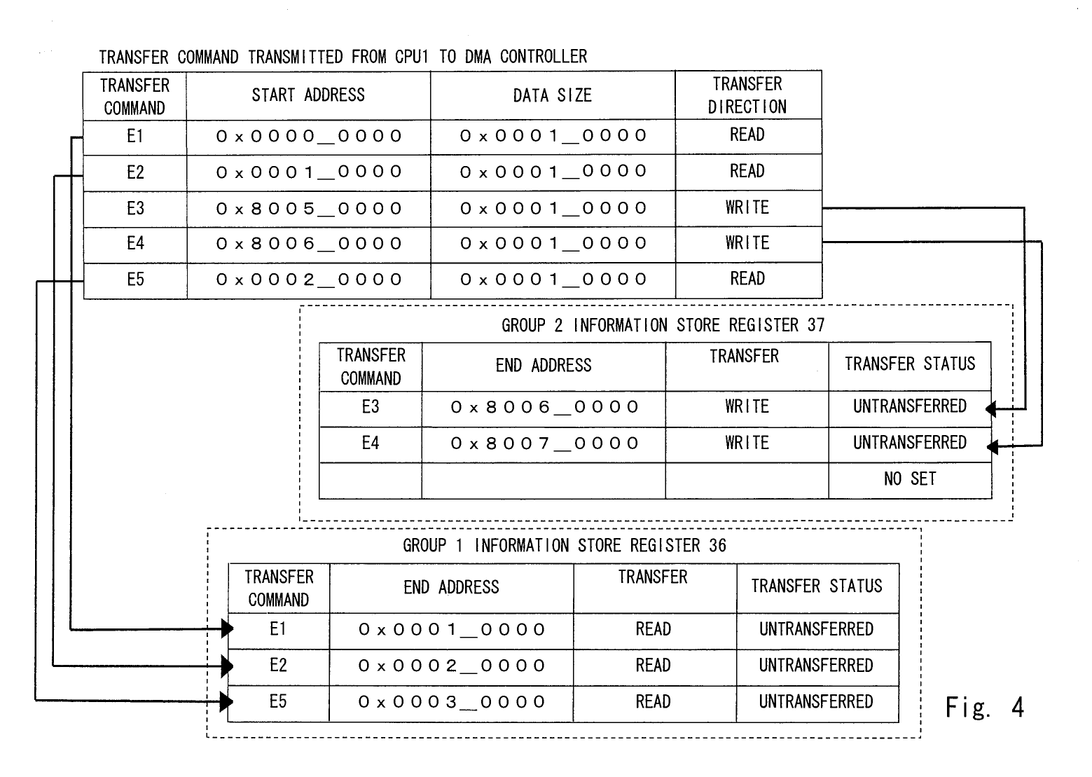

Note that, transfer direction from the I/O device 6 to the RAM 4 is hereinafter referred to as read, and data transfer from the RAM 4 to the I/O device 6 is hereinafter referred to as write (see FIG. 4). When DMA transfer to read-direction is performed, the DMA controller 5 writes data supplied by the I/O device 6 to the RAM 4 through the memory controller 3. When DMA transfer to write-direction is performed, the DMA controller 5 reads out data from the RAM 4 through the memory controller 3 and transfers the data to the I/O device 6. By this way, the DMA controller 5 executes data transfer (in other words, DMA transfer) without intervention of the CPU 1.

According to the exemplary embodiment, it is clear, as described hereinbelow that, the DMA controller 5 makes a group with each transfer command in a unit of application depending on continuity of transfer command sent from the CPU 1, and generates an interruption in a unit of this group. This reduces generation of unnecessary interruptions and thus the transfer efficiency of the bus 7 can be improved. Note that, the continuity of transfer command is equal to the continuity of DMA transfer.

As the CPU 1, the ROM 2, the memory controller 3, the RAM 4, the I/O device 6, and the buses 7-9 are common techniques for person skilled in the art, these explanations are omitted.

As mentioned above, the DMA controller 5 includes the boot register group 10 and the interrupt controller 11. The boot register group 10 includes plural registers and stores the transfer command which is transferred from the CPU 1 to the DMA controller 5 to each register. In particular, each resister of the boot register group 10 stores information that defines or shapes the transfer command, such as start address, data size or transfer direction. When the transfer command is stored in a boot register, the DMA controller 5 executes DMA transfer according to the transfer command. Note that, as shown in FIG. 4, a transfer command is specified by a start address, a data size and a transfer direction.

As mentioned above, the interrupt controller 11 includes the transfer command monitor 12, the transfer information manager 13 and the interruption generator 14. The transfer command monitor 12 receives individual transfer command which is transferred from the CPU 1, and obtains necessary information from the transfer command. The transfer information manager 13 determines continuity between a transfer command which is received this time and a transfer command which has been received before, groups plural transfer commands according to the determination result, and manages individual information of the individual transfer command according to grouping of the transfer commands. The interruption generator 14 generates an interrupt signal which informs the CPU of completion of the DMA transfer in a unit of group of the transfer command. Note that, the individual information relates to individual transfer command and corresponds to, for example, an identification value, an end address, a transfer direction and a transfer status.

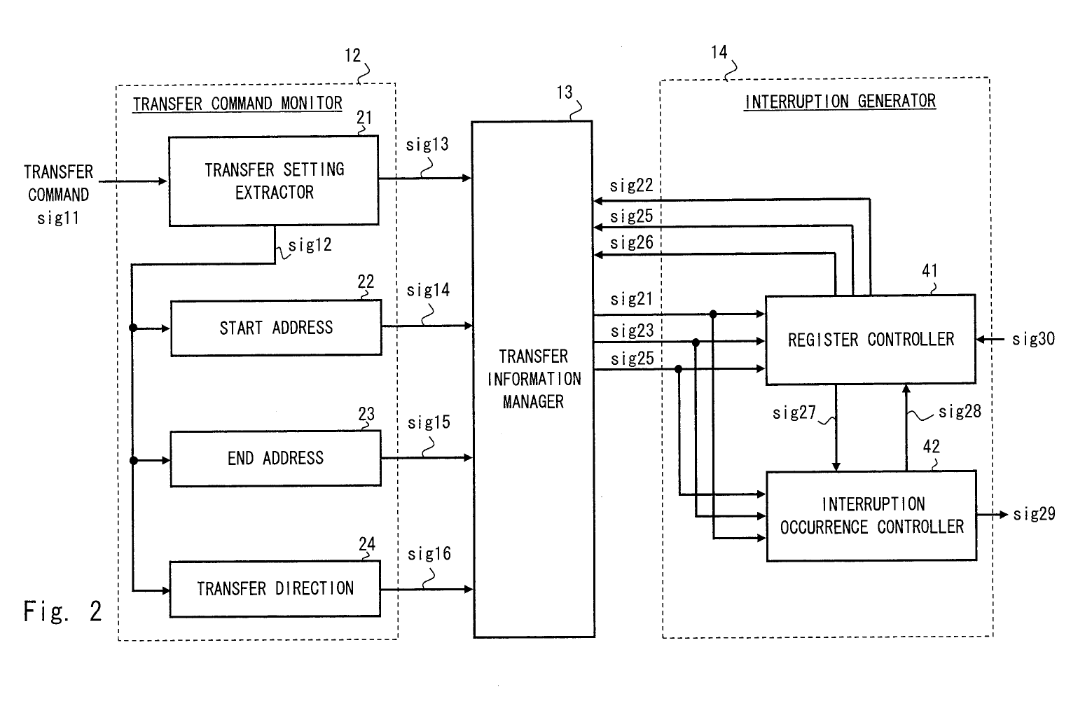

Hereinafter, a constitution and an operation of the interrupt controller 11 are described with referring to FIGS. 2-6.

As shown in FIG. 2, an output of the transfer command monitor 12 is connected to the transfer information manager 13. An output of the transfer information manager 13 is connected to the interruption generator 14. An output of the interruption generator 14 is connected to the transfer information manager 13.

As shown in FIG. 2, the transfer command monitor 12 includes a transfer setting extractor 21, a Start address calculator 22, an end address calculator 23 and a transfer direction extractor 24. The interruption generator 14 includes a register controller 41 and an interruption occurrence controller 42.

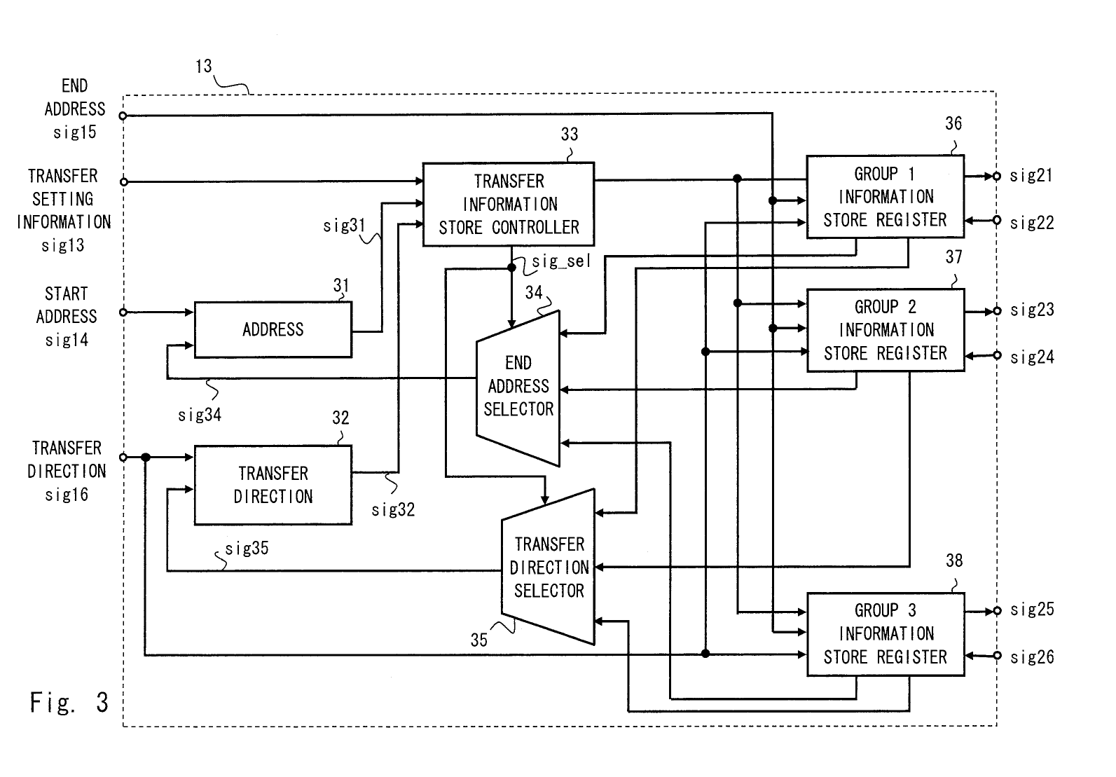

As shown in FIG. 3, the transfer information manager 13 includes an address comparator 31, a transfer direction comparator 32, a transfer information store controller 33, an end address selector 34, a transfer direction selector 35, a group 1 information store register (memory area) 36, a group 2 information store register (memory area) 37 and a group 3 information store register (memory area) 38. As a matter of convenience for explanation, the group 1 information store register 36 is also called an information store register 36. The group 2 information store register 37 and the group 3 information store register 38 are similar as the group 1 information store register 36. Note that, the number of information store registers can be any. At least one information store register needs to be provided. The number of information store registers is decided depending on the number of applications which require DMA transfer and the number of transfer commands which can be set in the boot register group 10.

As shown in FIG. 2, an output of the transfer setting extractor 21 is connected to the start address calculator 22, the end address calculator 23 and the transfer direction extractor 24. As shown FIGS. 2-3, the output of the transfer setting extractor 21 is connected to the transfer information manager 13. Similarly, an output of the start address calculator 22 is connected to the address comparator 31. An output of the transfer direction extractor 24 is connected to the transfer direction comparator 32 as well as the group 1 information store register 36, the group 2 information store register 37 and the group 3 information store register 38. An output of the end address calculator 23 is connected to the group 1 information store register 36, the group 2 information store register 37 and the group 3 information store register 38.

As shown FIGS. 2-3, outputs of the information store registers 36-38 are connected to the register controller 41 and the interruption occurrence controller 42. An output of the register controller 41 is connected to the information store registers 36-38. The output of the register controller 41 is connected to the interruption occurrence controller 42. An output of the interruption occurrence controller 42 is connected to the register controller 41.

As shown in FIG. 3, an output of the address comparator 31 is connected to the transfer information store controller 33. Similarly, an output of the transfer direction comparator 32 is connected to the transfer information store controller 33. An output of the transfer information store controller 33 is connected to the information store registers 36-38. An output of the transfer information store controller 33 is connected to the end address selector 34 and a control terminal of the transfer direction selector 35. The end address selector 34 is connected to the outputs of the information store registers 36-38. The transfer direction selector 35 is connected to the outputs of the information store registers 36-38.

As shown in FIG. 4, a transfer command includes an identification value of each transfer command (E1, E2, E3, E4, E5), a start address, a data size and transfer direction. Note that, the identification value can be omitted. Further, the start address, the data size and the transfer direction are digital values which indicate them. For convenience of explanation, for example, a data size is not indicated in order to avoid redundancy.

The transfer command monitor 12 obtains a start address, a data size and transfer direction based on a transfer command, and outputs them to the transfer information manager 13. The transfer information manager 13, as shown in FIG. 4, groups each transfer command according to relativity between each transfer command, and manages individual information of transfer commands in a unit of group. Note that, the transfer information manager 13 includes three information store registers 36-38 which are assigned to each group, and stores individual information of transfer commands in the three information store registers 36-38.

As shown FIG. 4, each information store register 36, 37 can store three transfer commands. Each information store register 36, 37 stores an identification value of each transfer command, an end address, a transfer direction and a transfer status. The information store register 38 is similar as the information store registers 36, 37. Note that, as described above, for convenience of explanation, the identification value can be omitted.

The register controller 41 of FIG. 2 changes a transfer status which is correlated with a transfer command in which DMA transfer is completed based on a signal (sig 30) which indicates a transfer command in which DMA transfer is completed.

According to the present exemplary embodiment, the interruption occurrence controller 42 does not generate interrupt every time individual transfer command is transferred, but generates interrupt at the timing when the interruption occurrence controller 42 detects completion of transfer of all transfer commands stored in the information store registers in a unit of information store register. Thus, the CPU 1 can be informed of the completion of DMA transfer in a unit of application. Then, it is possible to prevent unnecessary information from being transmitted through the bus 7 according to generation of redundant interruption and to improve transfer efficiency of the bus 7.

The transfer setting extractor 21 extracts transfer setting information included in a transfer command which is transferred from the CPU 1 to the DMA controller 5. More specifically, the transfer setting extractor 21 extracts a start address, a data size and transfer direction from a transfer command of FIG. 4, and outputs transfer setting signals (sig12, sig13) including them. Note that, more specifically, the transfer setting extractor 21 extracts necessary information from a transfer command based on values hold in the register of the boot register group 10.

The start address calculator 22 calculates a start address based on the output of the transfer setting extractor 21 (transfer setting signal). The start address calculator 22 generates a signal (sig 14) according to the start address included in the transfer setting signal and outputs it.

The end address calculator 23 calculates an end address based on the output of the transfer setting extractor 21 (transfer setting signal). The end address calculator 23 calculates an end address based on the data size and the start address included in the transfer setting signal, and generates a signal (sig15) according to the calculated result and outputs it.

The transfer direction extractor 24 calculates a transfer direction based on the output of the transfer setting extractor 21 (transfer setting signal). The transfer direction extractor 24 generates a signal (sig 16) according to the transfer direction included in the transfer setting signal and output it.

The transfer information store controller 33 of FIG. 3 makes the information store registers 36-38 output an end address of the transfer command stored in themselves in series to the address comparator 31 in order to determine continuity of the transfer command according to inputting of the transfer setting signal, and makes the address comparator 31 determine the continuity of a start address of the transfer command input this time and the transferred end addresses. Similarly, the transfer information store controller 33 makes the information store registers 36-38 output s transfer direction of the transfer command stored in themselves in series to the transfer direction comparator 32, and makes the transfer direction comparator 32 determine whether or not the transfer direction of the transfer commands input this time and the transferred transfer direction are same. Then the transfer information store controller 33 makes desired register store individual information of the transfer command of this time according to the determination result of the address comparator 31 and the transfer direction comparator 32. Note that, this individual information includes a transfer status (untransferred).

The transfer information store controller 33 controls selection conditions of the end address selector 34 and the transfer direction selector 35 by a select signal (sig_sel). For example, the transfer information store controller 33 controls the end address selector 34 so as to output the outputs, the group 1 information store register 36, the group 2 information store register 37, and the group 3 information store the register 38 in series. The transfer direction selector 35 is controlled similarly.

The address comparator 31 compares a start address of the transfer command of this time with an end address output selectively from the end address selector 34 and determines the continuity of both. The address comparator 31 outputs a determination signal corresponding to existence or nonexistence of the continuity between addresses which are comparative targets.

The transfer direction comparator 32 compares the transfer direction corresponding to the transfer command of this time with the transfer direction output selectively from the transfer direction selector 35 and determines whether or not they are same. The transfer direction comparator 32 outputs a determination signal corresponding to movements of the transfer directions which are comparative targets.

The end address selector 34 selects an end address which is individually output from the information store registers 36-38 based on a select signal, and outputs it.

The transfer direction selector 35 selects a transfer direction which is individually output from the information store registers 36-38 based on a select signal, and outputs it.

The information store registers 36-38 store each identification value of each transfer commend, each end address, each transfer direction and each transfer status (untransferred) according to an order from the transfer information store controller 33. The number of transfer commands that can be stored in the information store registers 36-38 can be determined based on the number of applications that require the DMA transfer, the number of transfer commands of DMA transfer divided with an application and bus traffic of the bus 7. If the number of transfer commands that can be stored in each information store register 36-38 is set is one, an interrupt can be generated every time individual DMA transfer is completed. In the exemplary embodiment, the number of transfer commands can be stored in that each information store register 36-38 is set to an integer of two or more. Note that, as stated in the above explanation, an individual value is set just for the sake of convenience, and thus the individual value may not be stored.

As described above, the register controller 41 updates a transfer status of the transfer command in which DMA transfer is completed based on a signal (sig 30). The signal (sig 30) specifies the transfer command in which DMA transfer is completed. For example, when the register controller 41 detects an end of a transfer command E3 based on the above signal (sig 30), the register controller 41 changes a transfer status of the transfer command E3 from “untransferred” to “transferred”. After that, the register controller 41 outputs a signal (sig 27) which indicates determination of generation of an interrupt into the interruption occurrence controller 42.

According to the signal (sig 27), the interruption occurrence controller 42 determines whether or not the transfer status of all of the transfer commands stored in the information store registers 36-38 where update to the transfer status is updated has been changed. The interruption occurrence controller 42 generates a signal (sig 29) based on the determination result. The signal (sig 29) informs the CPU 1 of the completion of the DMA transfer. The interruption occurrence controller 42 outputs a communication signal (sig 28) into the register controller 41. The communication signal (sig 28) communicates that an interrupt signal has been generated to the register controller 41.

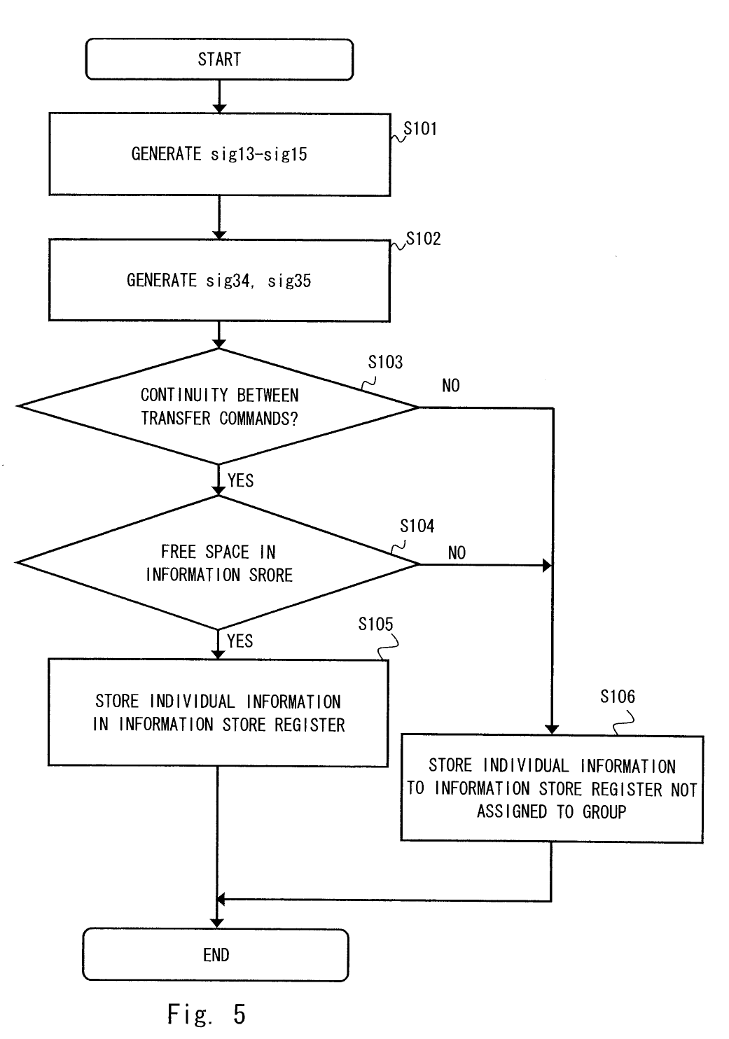

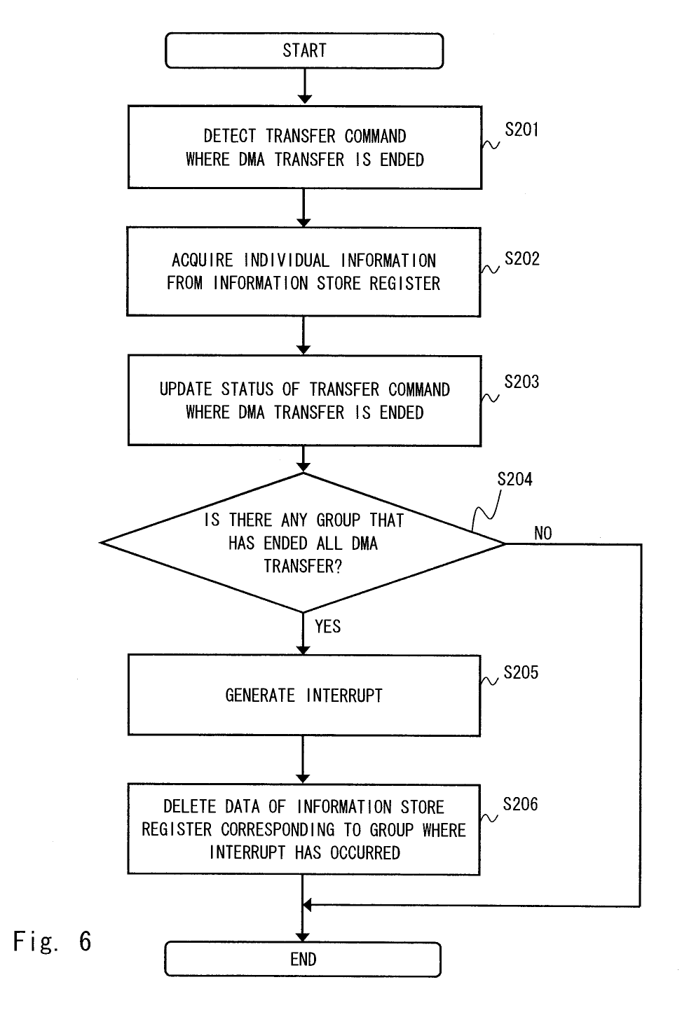

Next, an operation of the DMA controller 5, particularly, an operation of the interrupt controller 11 will be described with reference to FIGS. 5 and 6.

As shown in FIG. 5, first, the information processing device 100 starts DMA transfer. Specifically, the CPU 1 informs the DMA controller 5 of a transfer command which instructs DMA transfer. Accordingly, the DMA controller 5 registers the transfer command to a register included in the boot register group 10 and starts DMA transfer based on a received transfer command.

Next, the transfer command monitor 12 generates signals sig13-sig16 (step101). Specifically, step 101 is as follows. The transfer setting extractor 21 generates a transfer setting signal (sig 12) based on a transfer command (sig 11) transferred from the CPU 1 and outputs it. Subsequently, the start address calculator 22 calculates a start address based on the transfer setting signal, and outputs a signal (sig 14) according to the calculated result. The end address calculator 23 calculates an end address based on the transfer setting signal, and outputs a signal (sig 15) according to the calculated result. The transfer direction extractor 24 extracts a transfer direction based on the transfer setting signal, and outputs a signal (sig 16) according to the extracted result.

Next, the end address selector 34 and the transfer direction selector 35 generate signals sig34 and sig 35 (step 102). Specifically, step 102 is as follows. The transfer information store controller 33 outputs a select signal, and makes the end address selector 34 selectively output an end address which is supplied from a specific information store register. Similarly, the transfer information store controller 33 outputs a select signal, and makes the transfer direction selector 35 selectively output a transfer direction which is supplied from a specific information store register.

Next, the transfer information manager 13 determines whether or not the transfer commands have continuity (step 103). Specifically, the address comparator 31 compares a start address of the transfer command of this time with an end address output from the end address selector 34, determines whether or not these addresses have continuity, and outputs a determination signal according to the determination result. The transfer direction comparator 32 determines whether or not a transfer direction of the transfer command of this time and a transfer direction output from the transfer direction selector 35 are same, and outputs a determination signal according to the determination result. The transfer information store controller 33 determines a continuity of between the transfer command of this time and the transfer command read from the register based on the determination signal received from the address comparator 31 and the determination signal received from the transfer direction comparator 32. Note that, here, above comparison processing is repeatedly performed corresponding to the three information store registers 36-38. Further, data of lowermost revel is set to be output from each information store register.

Upon determination that there is continuity of between the transfer commands comes out, the transfer information store controller 33 determines whether or not there is a free space in the information store register which should store individual information of the transfer command of this time (step104). Specifically, the transfer information store controller 33 determines whether or not the number of transfer commands stored in the information store register which is detected as a storage location of information is less than M. Note that, M is natural number of one or more, and indicates the maximum number of the transfer commands which can be stored in the information store registers.

When there is a free space in the information store registers, the individual information is stored in the information store register which is detected as a storage location (step105). Specifically, the transfer information store controller 33 makes the information store resister detected as a storage location store an identification value of the transfer command, an end address and a transfer direction of the transfer command. Note that, as stated above, the identification value of the transfer command may or may not be registered.

In the case where the transfer information manager 13 determines there is no continuity in step 103 and the case where the transistor information store controller 33 determines that there is no free space in the resister in step 104, an information store register which is not assigned to a group of the transfer commands stores the individual information (step 106). Specifically, the transfer information store controller 33 makes an information store register which is assigned to a new group of the transfer commands store an identification value of the transfer command, an end address and a transfer direction.

Note that, in the case of FIG. 4, since there are continuity of addresses between transfer commands E1, E2 and E5, these commands are stored in the common information store register 36. Similarly, since there are continuity of addresses between transfer commands E3 and E4, these commands are stored in the common information store register 37. Note that, in both of the cases, the number of the individual information is not more than the number of the individual information that the information store registers can store.

Subsequently, further detailed operation of the DMA controller 5, particularly an operation of the interrupt controller 11, will be described with reference to FIG. 6.

First, the DMA controller 5 detects a transfer command in which DMA transfer has been ended (step201). Specifically, when DMA transfer based on the transfer command has been ended, the DMA controller 5 generates a signal (sig 30) specifying the transfer command, and supplies the signal (sig 30) to the register controller 41. Note that, signal sig 30 includes necessary information to specify a transfer command such as a start address, a data size and a transfer direction.

Next, the DMA controller 5 obtains individual information which is set to the information store registers 36-38 (step 202). Specifically, the register controller 41 receives output signals from the information store registers 36-38, and obtains necessary information to specify a transfer command such as an end address and a transfer direction.

Next, the DMA controller 5 updates a transfer status correlated with a transfer command in which the DMA transfer has been ended (step 203). Specifically, the register controller 41 specifies the transfer command in which the DMA transfer has been ended based on comparing result of transfer directions and end addresses, and updates the transfer status correlated with this transfer command from “untransferred” into “transferred”. The register controller 41 informs the interruption occurrence controller 42 of the fact of the update of the transfer status. Note that, the register controller 41 calculates an end address from a start address and a data size.

Next, the DMA controller 5 determines whether or not DMA transfer has been ended in a unit of group (step 204). Specifically, the interruption occurrence controller 42 determines whether all transfer commands of the information store registers in which the transfer status is updated have been ended based on the reference of the transfer status according to the communication from the register controller 41.

Next, when there is a group that DMA transfer has been ended, the DMA controller 5 generates an interrupt (step205). Specifically, the interruption occurrence controller 42 detects all of the transfer status correlated with each of all transfer commands stored in the information store registers in which the transfer status is updated have already been transferred, and generates an interrupt to inform the CPU 1 of the completion of the DMA transfer in a unit of group. The interruption occurrence controller 42 informs the register controller 41 of the interrupt.

Subsequently, the DMA controller 5 deletes data of a group in which the interrupt is generated (step 206). Specifically, the register controller 41 deletes a stored value of the information store register corresponding to a group in which the interrupt is generated.

As is clear from above description, according to the exemplary embodiment, the DMA controller 5 groups individual transfer command (DMA transfer) in a unit of application according to the continuity (continuity between DMA transfers) of a transfer command transferred from the CPU 1, and generates an interrupt in a unit of this group. This avoids generation of unnecessary interrupt information and improves transfer efficiency of the bus 7.

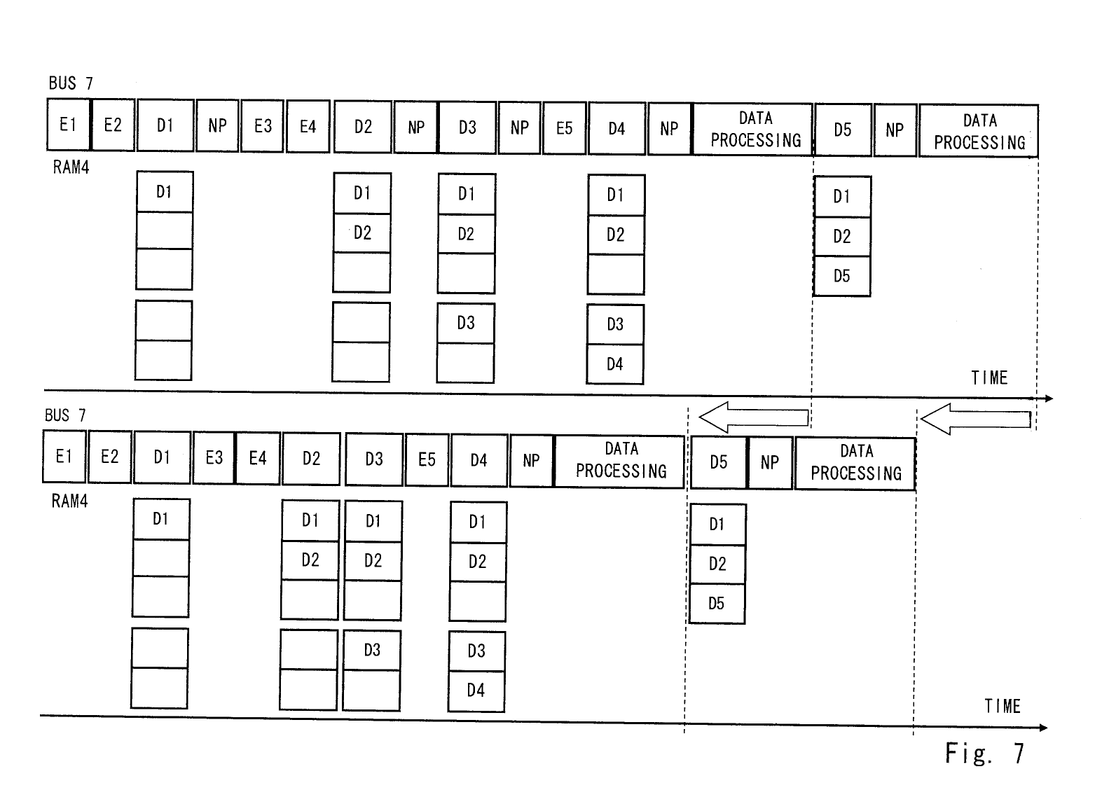

The effect which is realized by the DMA controller 5 of the exemplary embodiment will be described with reference to FIG. 7. Note that, as shown in FIG. 4, transfer commands are grouped preliminarily. Further, the present exemplary embodiment corresponds to a lower side of FIG. 7 and related art corresponds to an upper side of FIG. 7.

The DMA controller 5 receives a transfer command E1 from the CPU 1 through the bus 7, and executes DMA transfer corresponding to the command E1. Data D1 is transferred though the bus 7 in accordance with the DMA transfer of the transfer command E1. Other transfer commands E2-E5 are same as the command E1. Note that, the transfer command E2 corresponds to data D2, the transfer command E3 corresponds to data D3, the transfer command E4 corresponds to data D4, and the transfer command E5 corresponds to data D5.

As is clear from FIG. 7, in the present exemplary embodiment, an interruption processing (in FIG. 7, it is shown by NP) is performed in a unit of a group of transfer commands. This reduces a redundant interrupt signal which is transferred though the bus 7, and effectively inhibits the reduction of transfer efficiency of the bus 7. Note that, in the related art, the interrupt is generated every time the DMA transfer is completed, not in a unit of group of transfer commands. Such redundant interrupt increases traffic of the bus 7, and reduce transfer efficiency of the bus 7.

In the case of FIG. 7, although the interruption is generated five times in the related art, the interruption is reduced to twice in the exemplary embodiment. If it is assumed that transfer command:data transfer:system processing=1:2:2, total transfer time can be reduced by 10% and transfer rate can be increased by 10%.

Further, in the exemplary embodiment, the completion of DMA transfer which has sequential address can be transferred to the CPU immediately. This informs CPU of the completion of data transfer at an early point, and delay of start of use of transferred data by an application can be inhibited efficiently.

It is apparent that the present invention is not limited to the above embodiment but may be modified or changed without departing from the scope and spirit of the invention. This invention can be realized by using software or hardware. Any kind of individual information may be possible. Further, any means for determining continuity may be employed as well.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A DMA (Direct Memory Access) controller comprising:
an information manager which manages individual information by grouping the information according to grouping of a DMA transfer corresponding to relativity between the DMA transfers individually executed, the individual information corresponding to individual DMA transfer; and
a signal generator which generates a signal based on the individual information managed by the information manager, the signal indicating a completion of the DMA transfer in a unit of group of the DMA transfer.

2. The DMA controller according to claim 1, wherein the individual information includes a status value, the status value indicating a transfer state of the DMA transfer, and
the signal generator detects the completion of the DMA transfer in a unit of group of the DMA transfer based on the status value.

3. The DMA controller according to claim 2, wherein the signal generator updates the status value managed by the information manager based on information, the information indicating the completion of the DMA transfer transferred through a bus.

4. The DMA controller according to claim 1, wherein the information managers determines continuity of the DMA transfer which is a comparison target based on continuity between one start address and the other end address.

5. The DMA controller according to claim 2, wherein the information managers determines continuity of the DMA transfer which is a comparison target based on continuity between one start address and the other end address.

6. The DMA controller according to claim 3, wherein the information managers determines continuity of the DMA transfer which is a comparison target based on continuity between one start address and the other end address.

7. The DMA controller according to claim 1, wherein the information manager determines relativity of the DMA transfer which is a comparison target based on a result comparing transfer direction and the other transfer direction.

8. The DMA controller according to claim 2, wherein the information manager determines relativity of the DMA transfer which is a comparison target based on a result comparing transfer direction and the other transfer direction.

9. The DMA controller according to claim 3, wherein the information manager determines relativity of the DMA transfer which is a comparison target based on a result comparing transfer direction and the other transfer direction.

10. The DMA controller according to claim 4, wherein the individual information includes an end address of the DMA transfer.

11. The DMA controller according to claim 7, wherein the individual information includes information indicating a transfer direction of the DMA transfer.

12. The DMA controller according to claim 1, wherein the information manager includes a plurality of memory areas, the plurality of the memory areas storing the individual information in a unit of group of the DMA transfer.

13. The DMA controller according to claim 1, further comprising an information obtain unit which obtains or generates information based on a transfer command specifying the DMA transfer, the information indicating a start address defined the DMA transfer, an end address and a transfer direction, the information obtain unit further outputting the information to the information manager.

14. An information processing device comprising:
a CPU (Central Processing Unit);
a memory; and
a DMA controller connected to the CPU and the memory through a bus,
wherein the DMA controller comprising:
an information manager which manages individual information by grouping the information according to grouping of the DMA transfer corresponding to relativity between the DMA transfers individually executed; and
a signal generator which generates a signal based on the individual information managed by the information manager, the signal notifying the CPU of a completion of the DMA transfer in a unit of group of the DMA transfer.

15. A DMA managing method comprising:
storing individual information corresponding to individual DMA transfer in common memory area according to grouping of the DMA transfer corresponding to relativity between the DMA transfers individually executed; and
generating a signal based on the individual information stored in the memory area, the signal indicating a completion of the DMA transfer in a unit of group of the DMA transfer.
